(19) United States
(12) Patent Application Publication
(10) Pub. No.: US 2025/0229667 A1
(43) Pub. Date: Jul. 17, 2025

(54) CHARGING SYSTEM

(71) Applicant: TOYOTA JIDOSHA KABUSHIKI KAISHA, Toyota-shi (JP)

(72) Inventor: Akinori MORISHIMA, Naka-gun (JP)

(73) Assignee: TOYOTA JIDOSHA KABUSHIKI KAISHA, Toyota-shi (JP)

(21) Appl. No.: 18/898,700

(22) Filed: Sep. 27, 2024

(30) Foreign Application Priority Data
Jan. 12, 2024 (JP) 2024-003149

(51) Int. Cl. B60L 53/68; B60L 53/62; B60L 53/66; B60L 55/00

(52) U.S. Cl. CPC B60L 53/68; B60L 53/62; B60L 53/66; B60L 55/00; B60L 2240/70

(57) ABSTRACT

The charging system is configured to be able to charge each of the first power storage device and the second power storage device using external power supplied from an external power source to the facility. The first power storage device is mounted on a vehicle. The second power storage device is configured to enable power stored in the second power storage device to be supplied to the facility. The charging system includes a control device that controls charging of each of the first power storage device and the second power storage device. The control device is configured to prompt a user of the vehicle requesting charging of the first power storage device to select whether or not to restrict the requested charging, and to restrict the requested charging when the user chooses to restrict the charging.

### CROSS-REFERENCE TO RELATED APPLICATION

This application claims priority to Japanese Patent Application No. 2024-003149 filed on Jan. 12, 2024, incorporated herein by reference in its entirety.

### BACKGROUND

### 1. Technical Field

The present disclosure relates to a charging system.

### 2. Description of Related Art

Japanese Unexamined Patent Application Publication No. 2019-062618 (JP 2019-062618 A) discloses a charging system configured to enable each of a first power storage device and a second power storage device (fixed storage battery) mounted on a vehicle to be charged, by using external power. The external power is supplied from an external power source (for example, a commercial power source) to a facility (for example, a house). Also, the charging system predicts a homecoming time of the vehicle that includes the first power storage device, and performs pre-charging of the fixed storage battery until the homecoming time. In the pre-charging, a power portion for a peak cut is stored in the fixed storage battery in advance until the homecoming home.

### SUMMARY

The charging system described in JP 2019-062618 A predicts the homecoming time of the vehicle, and executes pre-charging of the fixed storage battery based on the prediction result. However, it is not necessarily easy to predict the homecoming time of the vehicle with high accuracy. Moreover, in a system that predicts the homecoming time based on information from a user of the vehicle, there is a possibility that the convenience of the user is impaired by requesting such information to the user. Moreover, it is difficult to apply the technology described in JP 2019-062618 A when the vehicle performs charging in a facility other than a house (for example, a commercial facility).

The present disclosure provides a charging system that can suppress a peak of a supply amount of external power to a facility from becoming excessively large, while suppressing a decrease of convenience of a user.

A charging system relating to one aspect of the present disclosure is configured to enable each of a first power storage device and a second power storage device to be charged, by using external power supplied from an external power source to a facility. The first power storage device is mounted on a vehicle.

The second power storage device is configured to enable power stored in the second power storage device to be supplied to the facility.

The charging system includes a control device that controls charging of each of the first power storage device and the second power storage device.

The control device is configured to prompt, to a user of the vehicle who requests charging of the first power storage device, a selection of whether to permit the requested charging to be restricted, and restrict the requested charging when the user selects to permit a restriction of charging.

According to the present disclosure, it becomes possible to provide a charging system that can suppress a peak of a supply amount of external power to a facility from becoming excessively large, while suppressing a decrease of convenience of a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a charging system according to an embodiment of the present disclosure;

FIG. 2 is a flowchart showing a process related to the vehicle charging control according to the present embodiment;

FIG. 3 is a diagram illustrating a selection request screen used in the vehicle charging control illustrated in FIG. 2;

FIG. 4 is a diagram showing a first modification of the processing flow shown in FIG. 2;

FIG. 5 is a diagram showing a second modification of the process shown in FIG. 2; and

FIG. 6 is a diagram illustrating a third modification of the processing flow illustrated in FIG. 2.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

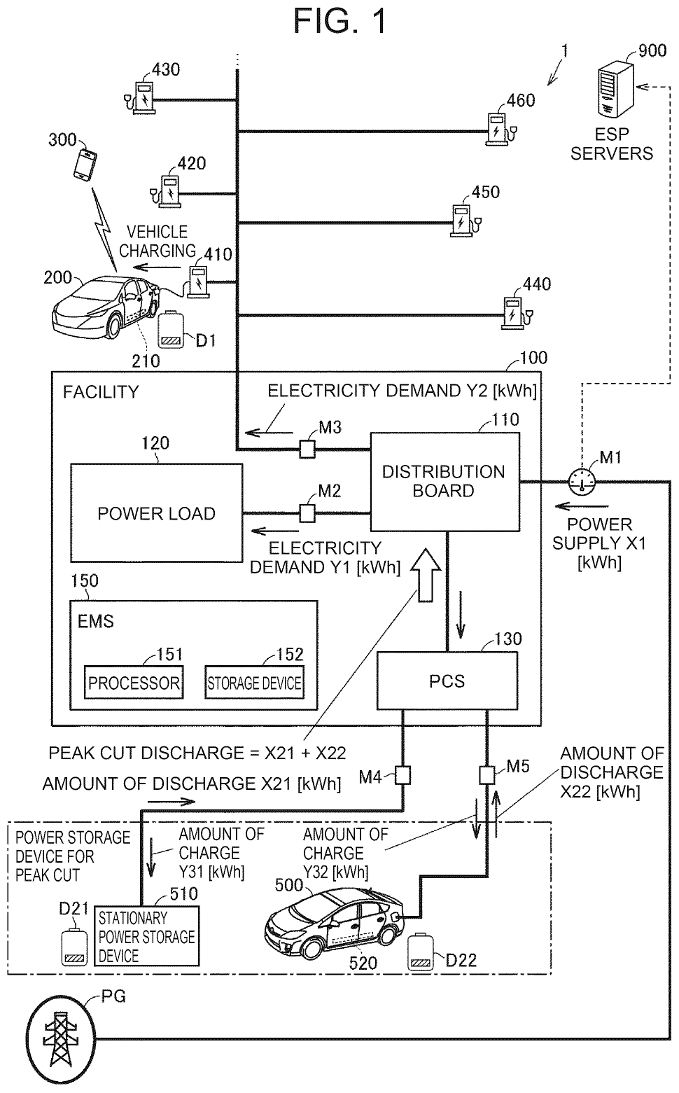

FIG. 1 is a diagram illustrating a charging system according to this embodiment. Referring to FIG. 1, the charging system 1 includes a facility 100, a plurality of power supply facility (including a power supply facility 410, 420, 430, 440, 450, 460), and a power storage device 510, 520 for peak cut. facility 100 include distribution board 110, electric power loads 120, PCS (Power Conditioning System) 130, and EMS (Energy Management System) 150. The facility 100 is, for example, a vehicle dealer. However, the present disclosure is not limited thereto, and the facility 100 may be another commercial facility (a department store, a road rest facility, an office, a factory, or the like), a public facility, or a house.

The distribution board 110 is electrically connected to the power system PG. Power (external power) is supplied from the power system PG to the distribution board 110. The power system PG is a power grid constructed by a transmission and distribution facility. The power system PG may include a substation. The power system PG may be connected to a power generation facility. The power system PG corresponds to an exemplary “external power source” according to the present disclosure.

The administrator of the facility 100 receives power from an energy service provider (ESP), such as a utility, for example. Specifically, the power system PG supplies AC power to the facility 100 (the distribution board 110). In this embodiment, the largest amount of electric power (hereinafter, referred to as “contract upper limit value”) that the facility 100 can receive from the electric power system PG is determined by the electric power contract. The contract upper limit may be expressed in terms of electric power supplied (kWh/h) per unit time (for example, 30 minutes). When the amount of electric power supplied from the power system PG to the facility 100 exceeds the contract upper limit value, a penalty (for example, a penalty) is imposed on the administrator of the facility 100. The electric energy supplied from the electric power system PG to the facility 100 is sequentially measured by an electric energy meter M1 (for example, a smart meter). The watt-hour meter M1 sequentially transmits the measured electric energy (supplied electric energy X1) to each of EMS150 and ESP servers 900.

PCS130 includes various types of circuitry for processes related to power conditioning (for example, power converting and input/output adjusting). PCS130 converts the AC power received from the distribution board 110 into DC power in accordance with an instruction from EMS150, and outputs the DC power to at least one of the power storage devices 510 and 520. The power storage device 510 is a stationary power storage device. The power storage device 520 is a power storage device mounted on the vehicle 500. Each of the power storage devices 510, 520 is charged by electric power from PCS130. PCS130 converts electric power for charging each of the power storage devices 510, 520. The power storage devices 510 and 520 are configured to be capable of supplying the electric power stored in the power storage devices 510 and 520 to the facility 100. A PCS130 converts electric power between each of the power storage devices 510, 520 and the distribution board 110. As a result, the electric power output from each of the power storage devices 510, 520 to the distribution board 110 becomes the electric power that can be used in the electric power load 120 or each power supply facility (such as the power supply facility 410). PCS 130 is configured to convert power for V2H (Vehicle to Home). Each of the power storage devices 510, 520 corresponds to an example of a “second power storage device” according to the present disclosure.

The distribution board 110 distributes external power inputted from the power system PG to a plurality of circuits (secondary circuits) in the facility 100. The secondary circuit may be protected with a fuse or a breaker. In this embodiment, the distribution board 110 distributes the inputted external power to the electric power loads 120, the respective electric power supply facilities (such as the electric power supply facilities 410), and PCS130. Power from the distribution board 110 may be supplied to the electric power load 120 via an outlet. The electric power load 120 may include, for example, lighting devices and air conditioning equipment. EMS150 may be powered by power from the distribution board 110 or may be powered by another power source (e.g., drive batteries).

The power supply facilities included in the charging system 1 function as a vehicle power supply facility (EVSE). The charging system 1 includes at least one of a AC power supply facility for outputting AC power and a DC power supply facility for outputting DC power. The vehicle 200 includes a power storage device 210, and can charge the power storage device 210 using, for example, the power supply facility 410. The vehicle 200 is configured to be able to travel using electric power output from the power storage device 210. Vehicle 200 includes an ECU (Electronic Control Unit (electronic control unit)). Vehicle 200 may be a battery electric vehicle (BEV) without an internal combustion engine, or may be a PHEV (plug-in hybrid electric vehicle) with an internal combustion engine. The power storage device 210 corresponds to an example of a “first power storage device” according to the present disclosure.

Each power supply facility included in the charging system 1 is configured such that the power storage device 210 of the vehicle 200 electrically connected to the power supply facility can be charged using external power supplied to the facility 100. Each power supply facility is configured to be electrically connectable to the vehicle 200 via, for example, a charging cable. In the example illustrated in FIG. 1, the leading end portion (connector) of the charging cable connected to the power supply facility 410 is connected (plugged in) to the inlet of the vehicle 200, and the vehicle 200 and the power supply facility 410 are electrically connected. The connector of the charging cable is configured to be attachable to and detachable from the inlet of the vehicle 200. Each power supply facility included in the charging system 1 is electrically connected to the distribution board 110, and electric power output from the distribution board 110 is supplied to each power supply facility. The power supply facility 410 charges the power storage device 210 of the vehicle 200 using external power supplied from the power system PG via the distribution board 110. EMS150 is configured to be able to communicate with the power supply facilities included in the 25 charging system 1. The power supply is controlled by a EMS150.

The mobile terminal 300 is carried by a user of the vehicle 200. The mobile terminal 300 is, for example, a smartphone including a touch panel display. An application software for using the charging system 1 is installed in the mobile terminal 300. The mobile terminal 300 is configured to be able to communicate with each of EMS150 and the vehicles 200 (in-vehicle ECU).

The charging system 1 further comprises a M5 from the watt-hour meter M2. The watt-hour meter M2 is located between the electric power load 120 and the distribution board 110, detects the amount of electric power consumed by the electric power load 120, and sequentially outputs the detected amount of electric power (demanded electric energy Y1) to EMS150. The watt-hour meter M3 is located between the power supply facilities and the distribution board 110 included in the charging system 1. The watt-hour meter M3 detects the total amount of electric power consumed by the respective power supply facilities (the sum of the amount of electric power demanded by all the power supply facilities included in the charging system 1), and sequentially outputs the detected amount of electric power (the demanded electric energy Y2) to EMS150. The watt-hour meter M4 is located between the power storage device 510 and PCS130. The watt-hour meter M4 detects the amount of electric power (discharged amount) output from the power storage device 510 to the facility 100 and the amount of electric power (charged amount) output from the facility 100 to the power storage device 510. The watt-hour meter M4 sequentially outputs the detected discharged electric energy X21 or charged electric energy Y31 of the power storage device 510 to EMS150. The watt-hour meter M5 is located between the power storage device 520 and PCS130. The watt-hour meter M5 detects the amount of electric power (discharged amount) output from the power storage device 520 to the facility 100 and the amount of electric power (charged amount) output from the facility 100 to the power storage device 520. The watt-hour meter M5 sequentially outputs the detected discharging amount X22 or charging amount Y32 of the power storage device 520 to EMS150.

The vehicle 200 detects the present storage amount (kWh) of the power storage device 210, and sequentially outputs the detected storage amount D1 of the power storage device 210 to EMS150 through the power supply facility when the power supply facility is connected to any of the power supply facilities included in the charging system 1. The power storage device 510 detects its present electricity storage amount (kWh) and sequentially outputs the detected electricity storage amount D21 of the power storage device 510 to EMS150. The power storage device 520 detects its present electricity storage amount (kWh) and sequentially outputs the detected electricity storage amount D22 of the power storage device 520 to EMS150.

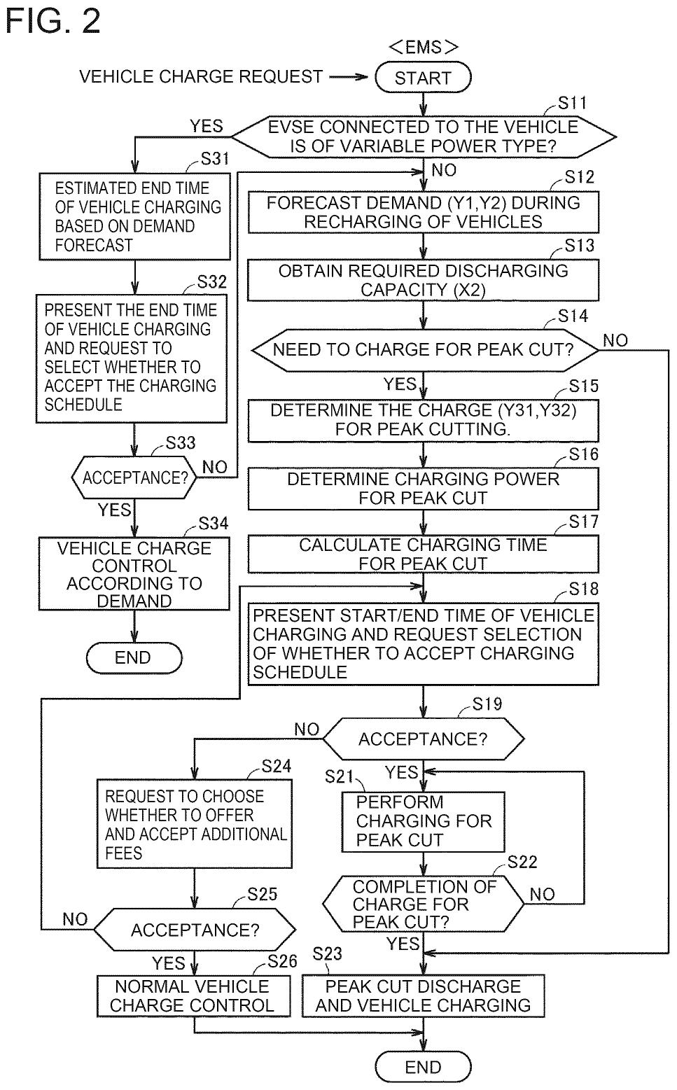

EMS150 may include a computer. EMS150 includes, for example, a processor 151 and a storage device 152. EMS150 stores the acquired supplied electric energy X1, discharged electric energy X21, X22, demanded electric energy Y1, Y2, charged electric energy Y31, Y32, and storage amount D1, D21, D22 in the storage device 152. EMS150 controls the charge of each of the power storage devices 210, 510, 520 and controls the discharging of each of the power storage devices 510, 520. The storage device 152 stores the position information and the specification information (rated output power indicating the power supply performance and the like) of each power supply facility included in the charging system 1 separately by the identification information for each power supply facility. The storage device 152 stores PCS130 and the power storage device 510, 520 in advance. In this embodiment, the control illustrated in FIG. 2 described below is executed by one or more processors executing programs stored in one or more storage devices. However, these processes may be executed only by hardware (electronic circuit) without using software. EMS150 corresponds to an exemplary “control device” according to the present disclosure.

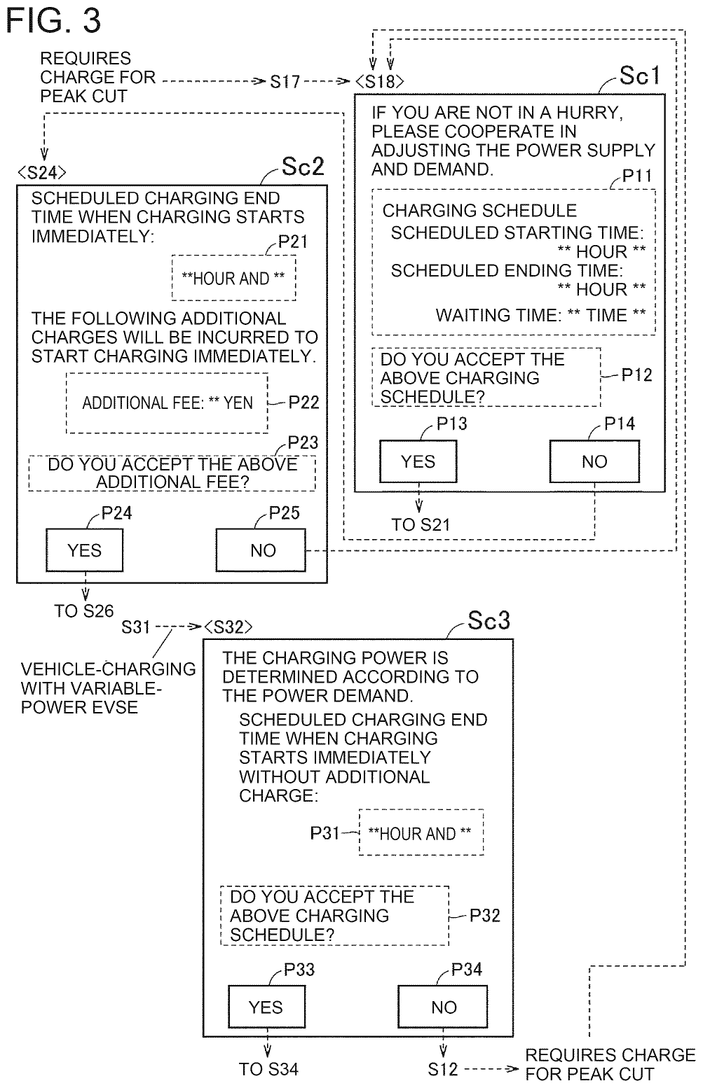

FIG. 2 is a flow chart showing a process related to vehicle charging (charging of the power storage device 210 mounted on the vehicle 200) performed by EMS 150. “S” in the flowchart means step. FIG. 3 is a diagram illustrating a screen for requesting a user to make a selection. Hereinafter, control executed in response to a vehicle charging request will be described with reference to FIG. 2 and FIG. 3.

For example, when the vehicle 200 is electrically connected (plugged in) to the power supply facility 410, the vehicle 200 requests EMS150 to charge the vehicle through the power supply facility 410. In addition, the vehicle 200 may transmit the target storage capacity set by the user to EMS150 through the mobile terminal 300. The power supply facility 410 requests EMS150 to charge the vehicle by transmitting the identity of each of the vehicles 200 and the power supply facility 410 connected to each other to EMS150. When EMS150 receives the vehicle charge request, it starts the process illustrated in FIG. 2. However, the start condition of the processing flow can be arbitrarily set.

Referring to FIG. 2, in S11, EMS150 determines whether the power of the power supply facility 410 electrically connected to the vehicles 200 can be limited. Specifically, the charging system 1 includes two types of power supply equipment (a first power supply equipment and a second power supply equipment). The first power supply facility is an output variable type power supply facility configured to be capable of controlling the magnitude of power supply power (power output from the power supply facility) within a predetermined range. The second power supply equipment is a power supply equipment that can control the execution/stop of the power supply, but cannot control the magnitude of the power supply. EMS150 determines which type of power supply facility the power supply facility 410 corresponds to based on specification information (for example, a model number or a control specification) of the power supply facility 410 stored in the storage device 152. When the power supply facility 410 is the first power supply facility, it is determined as YES in S11, and the process proceeds to S31. When the power supply facility 410 is the second power supply facility, it is determined as NO in S11, and the process proceeds to S12. EMS150 may determine S11 based on the data from the power supply facility 410.

In S12, EMS150 predicts the power consumption amount consumed by the facility 100 during the performance of the vehicle charge. The power consumption amount consumed by the facility 100 corresponds to the sum of the demanded electric energy Y1 and Y2. EMS150 may use the weather data to predict power consumption amount by the electric power loads 120. Note that the vehicle charge is started by a S23 or a S26 which will be described later.

In S13, EMS150 calculates the peak-cut discharge amount required for the vehicle charge by using the power consumption amount predicted by S12 and the upper limit value (for example, the contract upper limit value) of the supplied electric energy X1. The peak cut discharge amount corresponds to the sum of the discharged electric energy X21 and X22. The peak cut discharge is a discharge for suppressing the peak of the supply amount of the external power to the facility 100 from becoming larger than the upper limit value, and is executed by at least one of the power storage devices 510 and 520. EMS150 may determine a power storage device (at least one of the power storage devices 510 and 520) that causes the peak cut discharge to be executed based on the calculated peak cut discharge amount and the present power storage amount D21, D22. Note that the peak-cut discharging is started in a S23 described later.

In S14, EMS150 determines whether or not a charge for peak-cutting is required. Charging for peak cut is charging of a power storage device that causes peak cut discharge to be performed, and is started in a S21 described later. EMS150 may determine S14 using the peak-cut discharging amount calculated by S13 and the present power storage amount D21, D22. When the peak-cut discharging can be performed at the present storage amount D21, D22, it is determined as NO by S14, and the process proceeds to S23. On the other hand, when charge for peak cut is required (YES in S14), EMS150 determines the charge for peak cut by S17 from the following S15.

In S15, EMS150 uses the present storage amount D21, D22 to determine the charge amount (kWh) for peak cutting. The charge amount for peak cutting corresponds to at least one of the charged electric energy Y31 and Y32. In S16, EMS150 determines the charge power (kW) for peak cutting. EMS150 uses the power consumption amount predicted by S12 and the specification of the power supply facility 410 to determine the charge power for peak cutting. EMS150 determines the charge power for peak cutting so that the supplied electric energy X1 does not exceed a prescribed value (for example, a contract upper limit value). In S17, EMS150 calculates the charge times for the peak cut using the determined charge amounts and charge power for the peak cut. In this embodiment, the charge period calculated by S17 determines the condition for completing the charge for the peak-cut. Charging for peak cutting is completed at a timing when the charging time has elapsed since the start.

In the following S18, EMS150 prompts the user of the vehicle 200 to present the scheduled starting time and scheduled ending time of vehicle charging and to select whether or not to permit vehicle charging to be restricted. More specifically, EMS150 predicts the starting time of the vehicle charging using the charging times calculated by S17. For example, it is predicted that the vehicle charging is started at a timing when the charging for peak cutting is completed. Further, EMS150 predicts the end time of the vehicle charging using the scheduled start time of the vehicle charging, the specification information of the power supply facility 410, and the target storage amount of the vehicle charging. Then, EMS 150 notifies the mobile terminal 300 of the predicted times (the scheduled start time and the scheduled end time of vehicle charging), and requests the mobile terminal 300 to return whether or not to accept that the vehicle charging is started at the notified scheduled start time.

Upon receiving the reply from EMS150, the mobile terminal 300 displays, for example, the screen Sc1 shown in FIG. 3. The screen Sc1 displays a schedule P11 for charging the vehicle, a message P12 for prompting the user to perform an operation, and an operation unit P13, P14. The schedule P11 indicates the scheduled start time and the scheduled end time of the vehicle charging, and the time (time from the present time to the scheduled start time of the vehicle charging) for waiting for the completion of the charging for the peak cut. Each of the operation units P13, P14 receives an acceptance or rejection from the user regarding the vehicle charge indicated by the schedule P11.

In the following S19, EMS150 determines whether or not the user of the vehicle 200 has accepted the scheduled vehicle charge presented in S18. For example, EMS 150 determines which of the operation unit P13, P14 the user has operated on the screen Sc1 (FIG. 3). When the operaion unit P13 is operated, the mobile terminal 300 returns an acceptance to EMS150. Then, S19 determines YES, and the process proceeds to S21. On the other hand, when the operating unit P14 is operated, the mobile terminal 300 returns a rejection to EMS150. Then, S19 determines NO, and the process proceeds to S24.

In S21, EMS150 controls PCS130 so that the charging for peak-cutting is performed on at least one of the power storage devices 510 and 520 under the charging conditions determined by S15 to S17. In the following S22, EMS150 determines whether or not the charge for peak cutting has been completed. Specifically, the charge completion condition is not satisfied while the charge time determined by S17 does not elapse after the charge for peak cutting is started, and the charge completion condition is satisfied when the charge time elapses. While the charge completion condition is not satisfied (NO in S22), S21, S22 is repeated, and the charge for peak-cutting continues. When the charge completion condition is satisfied (YES in S22), the process proceeds to S23, and the charge for peak-cutting is stopped.

In S23, EMS150 starts vehicle-charging (requested charging) with peak-cut discharging. The peak cut discharge is performed by at least one of the power storage devices 510 and 520. EMS150 controls PCS130 such that peak-cut discharging is performed. The vehicle charging (charging of the power storage device 210) is executed while both the electric power generated by the peak-cut discharging and the external power from the electric power system PG are supplied to the facility 100. Electric power corresponding to the rated output of the electric power supply facility 410 may be supplied from the electric power supply facility 410 to the vehicle 200. The rated power of the power supply facility 410 is greater than the charge power for peak-cut determined by S16. In S23, EMS150 performs vehicle charging while supplying power from at least one of the power storage devices 510 and 520 to the facility 100 so that the supply amount (supplied electric energy X1) of the external power to the facility 100 does not exceed a prescribed value (for example, a contract upper limit value). Then, when the storage amount D1 of the power storage device 210 reaches the target electric storage amount, EMS150 ends the vehicle electric charge. Then, the processing flow ends. The target storage amount may be a value acquired from the vehicle 200 or may be a fixed value (for example, a value indicating full charge) set in advance.

In S24, EMS150 prompts the user of the vehicle 200 to present an additional fee associated with the immediate initiation of vehicle charging and to select whether to accept the payment of the additional fee. More specifically, EMS150 predicts the end time of the vehicle charging when the vehicle charging is immediately started, using the present time, the specification information of the power supply facility 410, and the target power storage amount of the vehicle charging. Then, EMS150 notifies the mobile terminal 300 of the predicted end time (scheduled end time) and the additional charge. The additional fee may be a fixed amount, or may be higher as the waiting time (the charge time calculated by S17) is longer. Upon receiving the notification from EMS150, the mobile terminal 300 displays, for example, a screen Sc2 illustrated in FIG. 3. The screen Sc2 displays the scheduled ending time P21 of the vehicle-charging, the additional fee P22, a message P23 prompting the user to perform an operation, and the operation unit P24, P25. Each of the operation units P24, P25 accepts an acceptance or rejection from the user with respect to the displayed additional fee P22.

In a subsequent S25, EMS150 determines whether the user of the vehicle 200 has accepted to pay the additional fee. For example, when the operation unit P24 is operated on the screen Sc2 (FIG. 3), the mobile terminal 300 returns the acceptance. As a result, it is determined that S25 is YES, and the process proceeds to S26. On the other hand, when the operation unit P25 is operated, the mobile terminal 300 returns a rejection. As a result, S25 determines NO, and the process returns to S18.

In S26, EMS150 initiates a vehicle charge (requested charging). In S26, no peak-cut discharging is performed. In S26, normal vehicle charge control is executed. EMS150 may leave charge control of the power storage device 210 to the vehicles 200 (in-vehicle ECU). Electric power corresponding to the rated output of the electric power supply facility 410 may be supplied from the electric power supply facility 410 to the vehicle 200. When the storage amount D1 of the power storage device 210 reaches the target electric storage amount, EMS150 ends the vehicle charge. EMS150 then charges the user for the additional fee presented in S24. As a result, the processing flow ends.

In S31, EMS150 predicts the ending time of the vehicle charge (see S34 below) with the variable output control of the power supply facility 410 (variable output type power supply facility). Specifically, EMS150 predicts the power consumption amount consumed by the facility 100 during the running of the vehicle charge in the same manner as S12. Subsequently, EMS150 predicts the power supply in the vehicle charge based on the predicted power consumption amount. The larger the power consumption amount, the smaller the power supply tends to be. Subsequently, EMS150 predicts the ending time of the vehicle charging using the present time, the predicted power supply power, and the target storage capacity of the vehicle charging.

In the following S32, EMS150 presents, to the user of the vehicle 200, the end time (scheduled end time) of the vehicle charging predicted by S31, and prompts the user to select whether or not to accept the vehicle charging at the proposed end time. More specifically, EMS150 notifies the mobile terminal 300 of the scheduled ending time of vehicle-charging. Upon receipt of this notification, the mobile terminal 300 displays, for example, a screen Sc3 illustrated in FIG. 3. The screen Sc3 displays the scheduled ending time P31 of the vehicle-charging, the message P32 prompting the user to perform the operation, and the operation unit P33, P34. Each of the operation units P33, P34 receives an acceptance or rejection from the user regarding the displayed scheduled ending time P31.

In the following S33, EMS150 determines whether or not the user has accepted the scheduled ending time presented in S32. For example, when the operation unit P33 is operated on the screen Sc3 (FIG. 3), the mobile terminal 300 returns the acceptance. As a result, it is determined that S33 is YES, and the process proceeds to S34. On the other hand, when the operation unit P34 is operated, the mobile terminal 300 returns a rejection. As a result, S33 determines NO, and the process returns to S12.

In S34, EMS150 starts vehicle-charging (requested charging) by variable-output control of the power supply facility 410. In S34, no peak-cut discharging is performed. In S34, EMS150 controls the power output (and thus the demanded electric energy Y2) of the power supply facility 410 so that the supplied electric energy X1 does not exceed a prescribed value (for example, a contract upper limit value) while checking the supply amount (the supplied electric energy X1) of the external power to the facility 100. When the power storage device 210 is charged by the electric power outputted from the power supply facility 410 and the storage amount D1 of the power storage device 210 reaches the target electric storage amount, EMS150 ends the vehicle charging. Then, the processing flow ends.

As described above, in the charging system 1 according to this embodiment, when the vehicle 200 requests charging of the power storage device 210 mounted on the vehicle 200, EMS150 (control device) prompts the user of the vehicle 200 to select whether or not to restrict the requested charging (S18 in FIG. 2). When the user's permission is obtained, the requested charging is prohibited until the peak-cut charging is completed (S21, S22 in FIG. 2). Since the charging of the power storage device 210 is prohibited, the external power is not used for the charging of the power storage device 210, so that the peak of the supply amount of the external power to the facility 100 is suppressed from becoming excessively large. In addition, in the charging system 1, a restriction (for example, prohibition of charging) of charging of the power storage device 210 is executed based on a user's selection. According to such a configuration, it is possible to prevent the convenience of the user from being excessively impaired due to the restriction of charging.

In this embodiment, when EMS150 chooses to permit the user to restrict the charging, S21 of FIG. 2 executes the peak-cut charging (charging of at least one of the power storage devices 510 and 520) while the requested vehicle-charging is restricted. Further, EMS150 releases the charge limit when the charge for peak cutting is completed. According to such a configuration, it is possible to store the amount of electric power for the peak cut discharge while the requested charging is limited. This makes it possible to cover the amount of electric power required by the peak cut discharge without excessively increasing the supply amount of external power supplied to the facility 100.

In this embodiment, EMS150 does not perform the requested charging during the peak-cut charge. Then, when the charging for the peak cut is completed, EMS 150 stops the charging for the peak cut and starts the charging of the power storage device 210, and performs the charging of the power storage device 210 while supplying the power from at least one of the power storage devices 510 and 520 to the facility 100 so that the supply amount of the external power to the facility 100 does not exceed the prescribed value (S23 in FIG. 2). According to such a configuration, by supplying power from at least one of the power storage devices 510 and 520 to the facility 100, it is possible to cover at least a part of the amount of power required for charging the power storage device 210. Therefore, it is possible to prevent the supply amount of external power supplied to the facility 100 from exceeding a prescribed value.

In this embodiment, EMS150 determines a condition (charging completion condition) under which the charging for peak-cutting is completed using the power consumption amount consumed by the facility 100 during the requested vehicle charging (S17 from S15 of FIG. 2). Therefore, it is easy to determine the charging completion condition so as to store a sufficient amount of electric power for peak cut discharge. In addition, by the process of S18 of FIG. 2, the scheduled starting time of the vehicle charging when the charging is restricted is notified to the user. Therefore, the user can determine whether or not to permit the vehicle charging restriction for the incentive in consideration of the charging start delay associated with the charging restriction.

In the above-described embodiment, EMS150 imposes a penalty (for example, an additional fee) on the user who has selected to refuse to restrict the charge (S26 in FIG. 2). Accordingly, an incentive is given to the user who has selected to permit the restriction of the charging. However, the present disclosure is not limited thereto, and EMS150 may pay a reward to the user who has selected to permit the limit of the charge. The reward may be paid in the form of a discount on the charge rate. The charging method of the charging fee may be connection time charging or pay charging. EMS150 may also incentive the user who has accepted the scheduled ending time in S33.

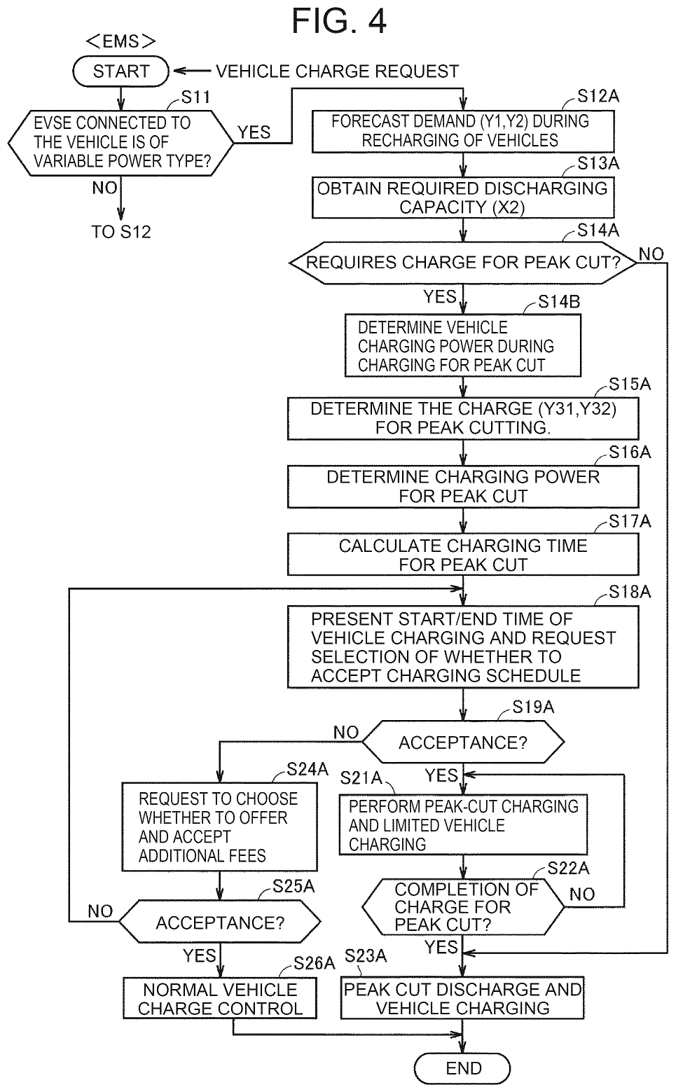

It should be noted that the power consumption amount consumed by the facility 100 may be reduced while the requested charging is limited. EMS150 may release the restriction of the charging at a timing when the restriction of the charging becomes unnecessary. Further, the restriction of charging is not limited to prohibition of charging. The state in which the charging is restricted includes a state in which the charging power is lower than that of the normal charging (charging in the state in which the charging is not restricted). EMS150 may execute the processing flow illustrated in FIG. 4 instead of the processing flow illustrated in FIG. 2. FIG. 4 is a diagram illustrating a first modification of the processing flow illustrated in FIG. 2.

Referring to FIG. 4, when the power supply facility 410 is the second power supply facility (NO in S11), the process proceeds to S12. The processes after S12 are the same as the processes after S12 shown in FIG. 2. When the power supply facility 410 is the first power supply facility (YES in S11), the same process as S14 is executed from S12 of FIG. 2 in S12A to S14A. Then, when it is determined that charging for peak-cutting is required (YES in S14A), EMS150 determines, in S14B, the charging power (limit) of the restricted vehicle charging (S21A) to be described later. EMS150 may decrease the limit as the power consumption amount predicted by S12A increases. The limit value may be a fixed value (for example, about 1 kW). In the subsequent S15A to S19A, a process corresponding to S19 is executed from S15 of FIG. 2. However, in S16A, EMS150 may further use the charging power (limit) determined by S14B in addition to the power consumption amount in S12A and the specification of the power supply facility 410 to determine the charging power for peak cutting. When the user rejects the charge schedule presented in S18A (NO in S19A), the process proceeds to S24A. The processing of S24A and the subsequent S25A, S26A is similar to the processing of S24, S25, S26 of FIG. 2, respectively. On the other hand, when the user accepts the charge schedule presented in S18A (YES in S19A), EMS 150 performs the charge for the peak cut while executing the vehicle charge while the power of the power supply facility 410 is limited in S21A. The vehicle charging is performed with the charging power (limit) determined by S14B. The limit is less than the charge power of a normal vehicle charge (S26A). EMS150 adjusts the vehicle-charging power by controlling the power of the power supply facility 410. The output of the power supply facility 410 is limited to the supply power corresponding to the limit value. In the following S22A, EMS150 determines whether or not the charge for peak cutting has been completed. When the charge completion condition is satisfied (YES in S22A), the process proceeds to S23A, and the charge for peak-cut is stopped. As a result, the output limit of the power supply facility 410 is released. In S23A, EMS150 performs the vehicle charge with peak-cut discharging. The process of S22A, S23A is similar to the process of S22, S23 of FIG. 2.

In the above-described modification illustrated in FIG. 4, when it is determined that the output of the power supply facility 410 can be restricted and the user chooses to permit the restriction of the charging (YES in S11 and YES in S19A), EMS150 performs the vehicle charging (requested charging) while the output of the power supply facility 410 is restricted during the charging for the peak cutting (S21A). Then, when the charging for the peak cut is completed (YES in S22A), EMS150 stops the charging for the peak cut and releases the power limit of the power supply facility 410, and executes the vehicle charging while supplying power from at least one of the power storage devices 510 and 520 to the facility 100 so that the supply amount of the external power to the facility 100 does not exceed the prescribed value (S23A). In such a configuration, the vehicle charging can be performed using the first power supply facility (output variable type power supply facility) with a charging power smaller than that of the normal charging. Then, the amount of electric power for peak cut discharge can be stored while vehicle charging is being performed in a state where the output (and thus the charging power) of the power supply facility 410 is limited. Since the limited charging power is small, an increase in external power is suppressed. Further, deterioration of the power storage device 210 is also suppressed. Then, by executing vehicle charging together with peak cut discharge, it is possible to suppress the supply amount of external power to the facility 100 from exceeding a prescribed value during vehicle charging.

The processing flows shown in FIG. 2 and FIG. 4 can be changed as appropriate. For example, the order of processing may be changed, or unnecessary steps may be omitted, depending on the purpose. Further, the contents of any of the processes may be changed, or steps may be added.

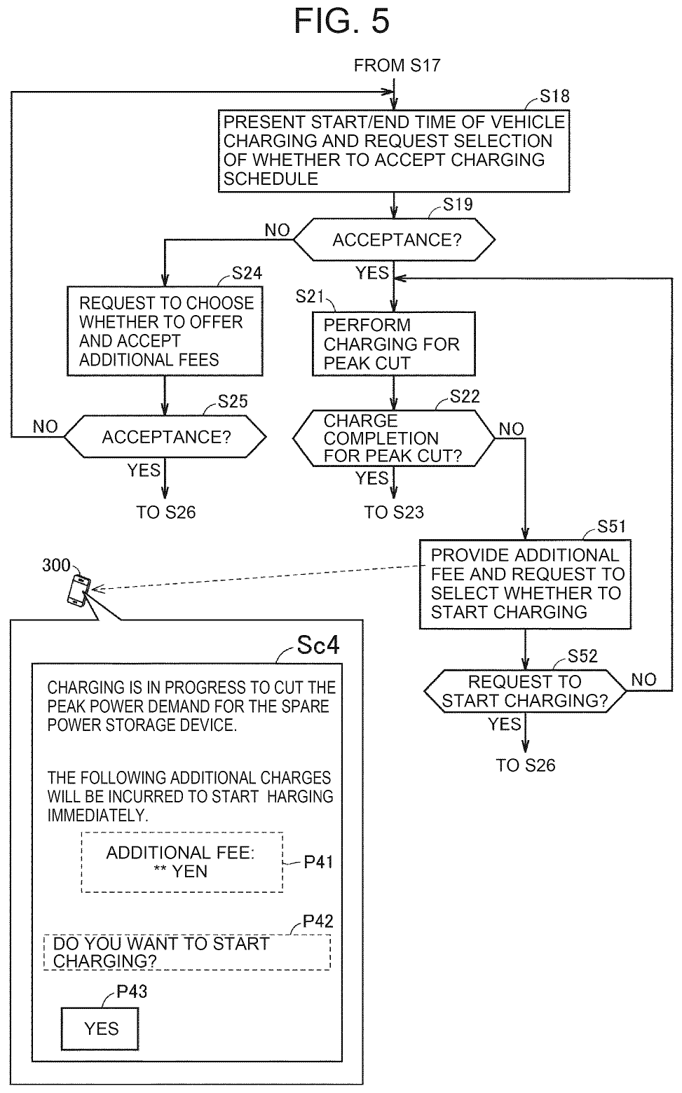

FIG. 5 is a diagram illustrating a second modification of the processing flow illustrated in FIG. 2. The process flow illustrated in FIG. 5 is basically the same as the process flow illustrated in FIG. 2, but steps (S51 and S52) executed during the charge for peak-cut are added. In S51, EMS150 prompts the user of the vehicle 200 to present an additional fee associated with the immediate initiation of vehicle charging and to select whether to accept the payment of the additional fee. EMS150 causes the mobile terminal 300 to display, for example, a screen Sc4. The screen Sc4 displays an additional fee P41, a message P42 prompting the user to perform an operation, and an operation unit P43. The operating unit P43 receives an acceptance from the user regarding the displayed additional fee P41. In a subsequent S52, EMS150 determines whether the user has accepted the presented additional fee. When the operation unit P43 is operated, the mobile terminal 300 returns the acceptance. As a result, it is determined that S52 is YES, and the process proceeds to S26. On the other hand, if EMS150 does not receive the acceptance reply from the mobile terminal 300, EMS150 determines NO in S52 and returns the process to S21. As a result, charging for peak cutting is continued.

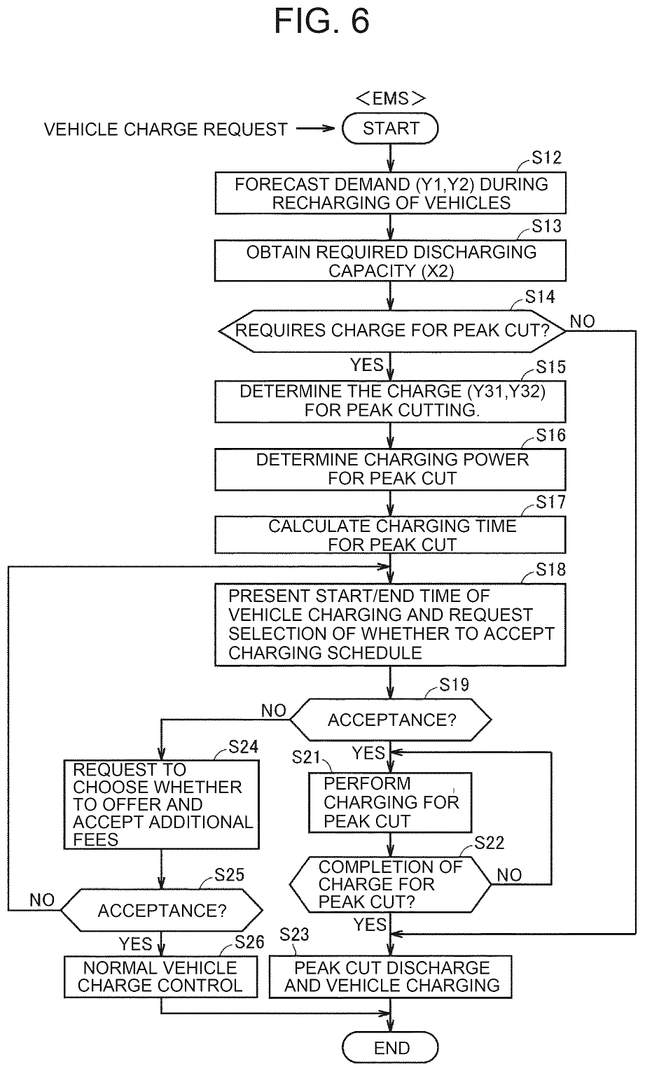

FIG. 6 is a diagram illustrating a third modification of the processing flow illustrated in FIG. 2. The processing flow illustrated in FIG. 6 is the same as the processing flow illustrated in FIG. 2 except that S34 is omitted from S11, S31.

The power system PG is not limited to a large-scale AC grid, and may be a microgrid or a DC (DC) grid. The charging method is not limited to contact charging (plug-in charging), and may be non-contact charging. The vehicle performing the non-contact charging may be considered to be electrically connected to the power supply equipment and the vehicle when the positioning of the power transmission unit on the power supply equipment side and the power reception unit on the vehicle side is completed. The power conversion circuit for charging and discharging the in-vehicle battery may be mounted not in the vehicle but in the power supply facility. The vehicle is not limited to a four-wheel passenger vehicle, and may be a bus or a truck, and may have any number of wheels. In the above-described embodiment, the mobile terminal 300 (smartphone) functions as a terminal (user terminal) of a user of the vehicle 200. However, the present disclosure is not limited thereto, and instead of a smart phone, an in-vehicle HMI (HumanMachineInterface), a tablet terminal, or a wearable device may be employed as the user terminal.

The number of power storage devices for peak cutting can be changed as appropriate. Only one power storage device (for example, only the power storage device 510) may be employed as the power storage device for peak cut. EMS150 functions may be implemented on the cloud by cloud computing.

Various modifications described above may be implemented in any combination.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A charging system, wherein
the charging system is configured to enable each of a first power storage device and a second power storage device to be charged by using external power supplied from an external power source to a facility,
the first power storage device is mounted on a vehicle,
the second power storage device is configured to enable power stored in the second power storage device to be supplied to the facility,
the charging system includes a control device that controls charging of each of the first power storage device and the second power storage device, and
the control device is configured to
prompt, to a user of the vehicle who requests charging of the first power storage device, a selection of whether to permit the requested charging to be restricted, and
restrict the requested charging when the user selects to permit a restriction of charging.

2. The charging system according to claim 1, wherein the control device is configured to execute charging of the second power storage device in a state where the requested charging is restricted when the user selects to permit the restriction of charging, and release the restriction of charging when charging of the second power storage device is completed.

3. The charging system according to claim 2, wherein the control device is configured to not execute the requested charging during charging of the second power storage device, stop charging of the second power storage device and start the requested charging when charging of the second power storage device is completed, and execute the requested charging while supplying power from the second power storage device to the facility such that a supply amount of the external power to the facility does not exceed a prescribed value.

4. The charging system according to claim 3, wherein
the control device is configured to enable communication with a terminal of the user, and
the control device is configured to
predict a power consumption amount consumed at the facility during execution of the requested charging,
determine a condition in which charging of the second power storage device is completed by using the predicted power consumption amount,
predict a start time of the requested charging by using the determined condition,
notify the predicted start time to the terminal of the user,
prompt, to the user, a selection of whether to permit the requested charging to be restricted by requesting, to the terminal of the user, a reply of whether to agree to charging of the first power storage device starting at the notified start time, and
provide an incentive to the user who selects to permit the restriction of charging.

5. The charging system according to claim 2, wherein
the charging system further includes power supply equipment,
the power supply equipment is configured to enable the first power storage device of the vehicle in a state of being electrically connected with the power supply equipment to be charged by using the external power supplied to the facility,
the control device is configured to determine whether an output of the power supply equipment is able to be restricted when the vehicle requests charging of the first power storage device in a state of being electrically connected with the power supply equipment, and
when determination is made that an output of the power supply equipment is able to be restricted and the user selects to permit the restriction of charging, the control device is configured to execute charging of the first power storage device in a state where an output of the power supply equipment is restricted during charging of the second power storage device, release an output restriction of the power supply equipment along with stopping charging of the second power storage device when charging of the second power storage device is completed, and execute charging of the first power storage device while supplying power from the second power storage device to the facility such that a supply amount of the external power to the facility does not exceed a prescribed value.
